(19) United States
(12) Patent Application Publication
(10) Pub. No.: US 2025/0364548 A1
(43) Pub. Date: Nov. 27, 2025

(54) POSITIVE ELECTRODE ACTIVE MATERIAL AND METHOD FOR MANUFACTURING A POSITIVE ELECTRODE ACTIVE MATERIAL

(71) Applicant: Umicore, Brussels (BE)

(72) Inventors: JooEun HYOUNG, Cheonan Chungcheongnam-do (KR); Maxime BLANGERO, Cheonan Chungcheongnam-do (KR); HanSol YONG, Cheonan Chungcheongnam-do (KR); Tijl Crivits, Olen (BE)

(21) Appl. No.: 18/873,800

(22) PCT Filed: Jun. 12, 2023
(86) PCT No.: PCT/EP2023/065604

§ 371 Date: Dec. 11, 2024

(30) Foreign Application Priority Data
Jun. 13, 2022 (EP) 22178747.6

(51) Int. Cl. H01M 4/525; C01G 53/44

(52) U.S. Cl. CPC H01M 4/525; C01G 53/44; C01P 2002/50; C01P 2002/72; C01P 2002/74; C01P 2004/03; C01P 2006/40

(57) ABSTRACT

Positive electrode active material, wherein the metal has a composition M, which consists of Ni in a content x, Mn in a content y, Co in a content z, and A in a content a. A is at least one chemical element other than Li, Ni, Mn, Co, and O. x, y, z, and a are expressed as molar contents and x+y+z+a=100%. Further, x≥70.0%, 0≤y≤30.0%, 0≤z≤30.0%, 0≤a≤5.0%, and an X-Ray diffractogram from Cu K-α X-ray radiation source of the positive electrode active material has a (003) peak at 2θ=17.0° to 20.0° and (104) peak at 2θ=43.0° to 46.0°. The ratio (maximum intensity of the (003) peak)/(maximum intensity of the (104) peak) is at least 1.880.

The present invention relates to a positive electrode active material comprising lithium and a metal other than lithium and oxygen, and even more in particular a positive electrode active material in which the metal has a high Ni content, typically 70 mol % or higher relative to the total transition metal content.

Such positive electrode active material is known from e.g. KR20210018139 A.

The positive electrode active materials preferably have an ordered crystal structure. However, in the material according to the prior art, Ni²⁺ is present on Lit sites in the crystal lattice, which reduces performance (due to increase of soluble base content at the surface and formation of an insulating surface layer by Li⁺ substitution from Ni²⁺).

It is well known that peak intensity ratio of (003)/(104) peaks in an XRD diffractogram can serve as a reliable indicator for the degree of cation mixing, in other words Ni²⁺ occupancy on Li⁺ sites in the layered oxide.

This is a particularly relevant for monolithic positive electrode active materials, which are produced at a higher temperature than poly-crystalline positive electrode active materials.

In the manufacture of such positive electrode active materials a certain amount of unreacted Li compound, usually as LiOH, may remain. This is undesirable for the performance of the positive electrode active material in a battery and it also means that more lithium source material needs to be used than would strictly been needed, leading to a waste of lithium source material.

Some efforts have been described to increase the battery performance through the temperature profile in the heating of positive electrode active materials. However, most of these efforts focus on stepwise increase of the heating temperature.

On the contrary, there are only very few publications directed at managing the cooling profile.

For example, WO2020216888A1 to Umicore describes a cooling in three stages:
Cooling to lower than 700° C.,
Cooling than lower than 550° C. at a cooling rate of 2-10° C./min,
Cooling to ambient temperature.

CN110233250A describes process with stepwise increase of the heating temperature followed by a second heating step at a reduced temperature of 600° C. to 800° C.

US2009299922A1 to Toda Kogyo describes cooling rates of positive electrode active material of less than 20° C./min, more specifically between 3° C./min and 20° C./min, or 3° C./min and 14° C./min, or from 3° C./min to 10° C./min, or from 3° C./min to 9° C./min, or at a cooling rate of less than 8° C./min.

US2013011726A1 to Mitsubishi describes lowering the temperature of the furnace interior at a cooling rate of generally 0.1-15° C./min.

However, there is still a need to provide an improved industrial scale process that allows for positive electrode active materials with reduced the level impurities and improved distribution of the lithium for reaching improved battery performance.

The inventors now have surprisingly found a method according to the present invention reduces the level of lithium impurities and improves the positive electrode active material.

Accordingly, a first aspect of the present invention is positive electrode active material comprising lithium and a metal other than lithium and oxygen, wherein the metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %,
wherein x≥70.0 mol %,
wherein 0≤y≤30.0 mol %,
wherein 0≤z≤30.0 mol %,
wherein 0≤a≤5.0 mol %,
   wherein an X-Ray diffractogram obtained from Cu K-α X-ray radiation source of the positive electrode active material has a (003) peak located at 2θ=17.0° to 20.0° and (104) peak located at 2θ=43.0° to 46.0°, wherein the ratio (maximum intensity of the (003) peak)/(maximum intensity of the (104) peak) is at least 1.880.

The advantage is such positive electrode active materials have a better performance than known positive electrode active materials.

Preferably, x, y, z, and a are measured by ICP-OES (Inductively coupled plasma).

In one embodiment, element A is selected from the group consisting of Ag, Al, As, Au, B, Ba, Bi, Ca, Ce, Cd, Cr, Cs, Eu, Fe, Ga, Ge, Hg, Sb, Se, In, Ir, K, La, Mg, Mo, Na, Nb, Nd, Os, P, Pb, Pd, Pr, Pt, Rb, Re, Rh, Ru, S, Sc, Se, Si, Sm, Sr, Ta, Te, Ti, Y, V, W, Zn, and Zr or combinations thereof.

Preferably, element A is selected from the group consisting of Al, As, B, Ba, Ca, Ce, Cd, Cr, Cs, Fe, Ga, Ge, Se, In, Ir, K, Mg, Mo, Na, Nb, Nd, P, Pd, Pt, S, Sc, Se, Si, Sr, Ta, Te, Ti, Y, V, W, Zn, and Zr or combinations thereof.

Even more preferably, element A is selected from the group consisting of Al, B, Ba, Ca, Cr, Fe, Mg, Mo, Nb, S, Si, Sr, Ti, Y, V, W, Zn, and Zr, or combinations thereof.

Preferably, 0<y≤30.0 mol % and 0<z≤30.0 mol %

### XRD Diffractogram

In a preferred embodiment, the ratio (maximum intensity of the (003) peak)/(maximum intensity of the (104) peak) is at least 1.900 and more preferably at least 1.920.

Hereby the beneficial effect of the present invention is present to an even larger degree.

In a preferred embodiment, the ratio (maximum intensity of the (003) peak)/(maximum intensity of the (104) peak) is at most 3.000.

In a preferred embodiment, the molar ratio: Li/(other metal elements than Li) in the first positive electrode active material is at least 0.90 and at most 1.10.

### High Nickel Positive Electrode Active Material

The present invention concerns in particular a high nickel positive electrode active material. Accordingly, in preferred embodiments, x, y, z are:
x>80.0 mol % and preferably x>85.0 mol % and more preferably x>88.0 mol %; and/or
x<98.5 mol % and preferably x<97.0 mol %; and/or
y≤20.0 mol % and preferably y≤10.0 mol %; and/or
z≤20.0 mol % and preferably z≤10.0 mol %; and/or
(y+z)>1.0 mol % and preferably (y+z)>2.5 mol %; and/or
y>0.5 mol % and z>0.5 mol %.

### LiOH Content

In a preferred embodiment the positive electrode active material comprises LiOH in a content of at most 0.20 wt. %, and preferably at most 0.15 wt % relative to the total weight of positive electrode active material, wherein the content of LiOH is measured by acid-base titration as described in the description.

LiOH impurity in the positive electrode active material significantly reduces the performance of the final battery, and therefore needs to be reduced as much as possible.

In a preferred embodiment, the molar ratio: Li/(other metal elements than Li) in the first positive electrode active material is at least 0.90 and at most 1.10.

### Monolithic

Preferably, the positive electrode active material is a powder, in other words a plurality of particles. More preferably, the positive electrode active material is a powder in which a majority of the particles are monolithic particles. Such a powder is otherwise known as a monolithic particle-based powder.

A particle is considered to be monolithic if it consists of only one primary particle or at most four, preferably at most three, constituent primary particles, as observed in a SEM image. An example of a powder with monolithic particles is shown in FIG. 3.

For the determination of monolithic particles, primary particles which have a largest linear dimension as observed by SEM which is smaller than 20% of the median particle size D50 of the particle as determined by laser diffraction are ignored. This avoids that particles which are in essence monolithic, but which may have deposited on them several very small other primary particles, are inadvertently considered as not being monolithic.

Preferably at least 50%, more preferably at least 80% of the particles in a field of view of at least 45 μm×at least 60 μm (i.e. of at least 2700 μm²), preferably of: at least 100 μm×100 μm (i.e. of at least 10,000 μm²) in a SEM image of said positive electrode active material powder are monolithic.

A primary particle can also be called a grain, so that primary particles may be distinguished from each other by observing grain boundaries.

The present invention also concerns a first method for manufacturing a positive electrode active material comprising lithium and a metal other than lithium and oxygen,, wherein said metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %, wherein x≥70.0 mol %, wherein 0≤y≤30.0 mol %, wherein 0≤z≤30.0 mol %, wherein 0≤a≤5.0 mol %,

comprising the consecutive steps of:
a. heating a precursor material at a heating temperature T1 between 750° C. and 1000° C., preferably between 800° C. and 950° C., and more preferably between 850° C. and 925° C. for a time period t1 between 2 and 20 hours, preferably, between 3 and 15 hours, even more preferably between 4 and 10 hours to obtain a heated product,
b. cooling the heated product to a second temperature T2 between 600° C. and 800° C., preferably between 625° C. and 775° C., even more preferably between 650° C. and 750° C., and even more preferably between 675° C. and 725° C. to obtain a second heated product, wherein the average cooling rate is between 10° C./h and 50° C./h, preferably between 20° C./h and 40° C./h, and more preferably between 25° C./h and 35° C./h, to obtain a first cooled product,
c. further cooling the first cooled product to obtain a second cooled product preferably to ambient temperature, wherein the further cooling preferably is a natural cooling,
d. milling the second cooled product to obtain a milled product,
e. heating the milled product at a temperature T3 between 200° C. and 900° C. to obtain the positive electrode active material.

In a preferred variant of the first method, during step b the heated product is subjected to a temperature which is reduced over the duration of the second heat treatment step at an average rate of at most 45° C./hour, preferably at most 35° C./hour.

In a preferred variant of the first method, during the entire duration of step b the heated product is subjected to a temperature which reduces over time or stays constant over time. Obviously, such a method may be executed in industrial furnaces, in which rapid temperature changes are not possible, so that these terms have to be understood against the background of what is in practice possible in industrial scale furnaces.

In one embodiment, the temperatures of the methods of the present invention are the setting temperature of the furnace.

In a preferred variant of the first method, during at least part of the duration of step b, and preferably during the entire duration of step b, the heated product is subjected to a temperature which is reduced over time at a constant rate.

The present invention also concerns a second method for manufacturing a positive electrode active material, comprising lithium and a metal other than lithium and oxygen, wherein said metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %, wherein x≥70.0 mol %, wherein 0≤y≤30.0 mol %, wherein 0≤z≤30.0 mol %, wherein 0≤a≤5.0 mol %,

comprising the consecutive steps of:
a. heating a precursor material at a heating temperature T1 between 750° C. and 1000° C., preferably between 800° C. and 950° C., and more preferably between 850° C. and 900° C. for a time period t1 between 2 and 20 hours, preferably, between 3 and 15 hours, even more preferably between 4 and 10 hours to obtain a heated product,
b. cooling the heated product to a second temperature T2 between 650° C. and 900° C., preferably between 700° C. and 875° C., even more preferably between 750° C. and 850° C., and even more preferably between 775° C. and 825° C. and keeping the plateau temperature T2 for a plateau time t2 between 5 and 20 hours, preferably, between 7.5 and 17.5 hours, even more preferably between 10 to 15 hours to obtain a first cooled product,
c. further cooling the first cooled product to obtain a second cooled product, preferably to ambient temperature, wherein the further cooling preferably is a natural cooling,
d. milling the second cooled product
e. heating the milled product at a temperature T3 between 200° C. and 900° C. to obtain the positive electrode active material.

The inventors have found that the cooling profile considerably improves the product properties and results in the positive electrode active materials of the present invention.

The cooling profile leads to a positive electrode active material having a reduced LiOH content in accordance with the present invention. Consequently, the positive electrode active material has a better electrochemical performance. Moreover, the positive electrode active material requires less or no aftertreatment such as washing.

Also, no excess, or a lower excess of lithium source material is required, compared to traditional methods.

The high heating temperature is needed to obtain a monolithic product. At such temperature, a small amount of unreacted Li in the form of Li₂O will remain, due to the natural thermodynamical equilibrium. When exposed to atmosphere comprising moisture, Li₂O forms LiOH. Step b at a decreased temperature shifts the thermodynamic equilibrium. Consequently, the Li₂O re-enters the positive electrode active material lattice, thereby reducing the amount of lithium impurity compound in the positive electrode active material.

Also, the method allows the manufacture of a positive electrode active material, preferably a positive electrode material according to the present invention.

The following preferred variants are applicable to both the first and the second method.

In a preferred variant, x, y, z, and a are measured by ICP-OES (Inductively coupled plasma).

In a preferred variant, ΔT defined as T1−T2 is between 20° C. and 400° C., preferably between 50° C. and 350° C.

### Milling

In one embodiment, the positive electrode active material powder form is obtained through milling. Both wet and dry milling is according to the present invention. Preferably, the wet milling is in water or a water-based solution.

In a preferred variant, the method comprises heating the ball milled positive electrode active material at a temperature T3 between 200 and 900° C.

In a preferred variant, the method comprises heating the ball milled positive electrode active material at a temperature T3 between 200 and 500° C. for a duration of at least 30 minutes and at most 1200 minutes.

### Positive electrode active material composition

In a preferred variant, x≥80.0 mol %, more preferably x≥85.0 mol %, and even more preferably x≥88.0 mol %

In a preferred variant, x<100.0 mol %, more preferably x<98.5 mol %, and even more preferably x<97.0 mol %.

In a preferred variant, (y+z)>0, more preferably (y+z)>1.5 mol %, and even more preferably (y+z)>3.0 mol %.

In a preferred variant, x<97.0 mol % and y>1.0 mol % and z>mol 1.0%.

In a preferred variant, the positive electrode active material is a powder.

In a preferred variant, a molar ratio: Li/(other metal elements than Li) in the positive electrode active material is at least 0.90 and at most 1.10.

In a preferred variant, the precursor comprises a source of M and a source of Li, preferably both in an oxidized state.

In a preferred variant, y≤15.0 mol %, and more preferably y≤7.5 mol %.

In a preferred variant, z≤15.0 mol %, and more preferably z≤7.5 mol %.

In a preferred variant of the first method or the second method, the positive electrode active material is a positive electrode active material according to the present invention.

In a preferred embodiment of the positive electrode active material according to the present invention, the positive electrode active material is manufactured by a method according to the present invention.

### BRIEF DESCRIPTION OF THE FIGURES

FIG. 1 shows exemplary temperature profiles of CEX2.1 according to the present invention.

FIG. 2 shows exemplary temperature profiles of CEX6.2 according to the present invention.

FIG. 3 shows FE-SEM image of EX5 having monolithic morphology.

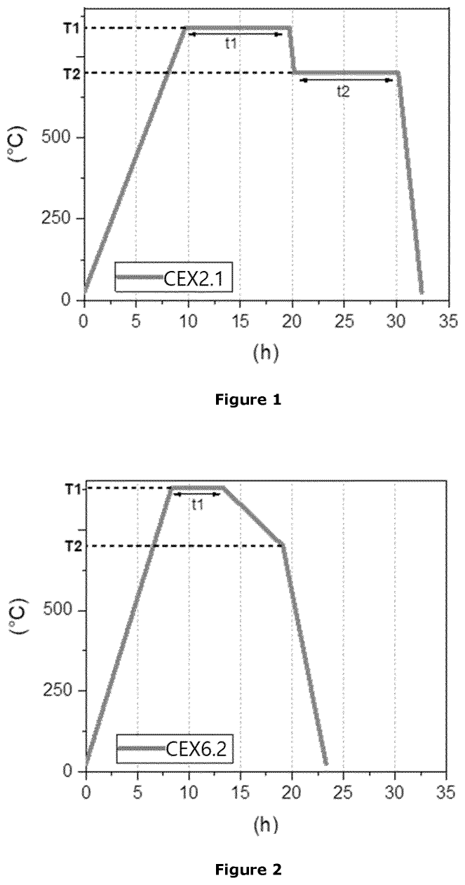

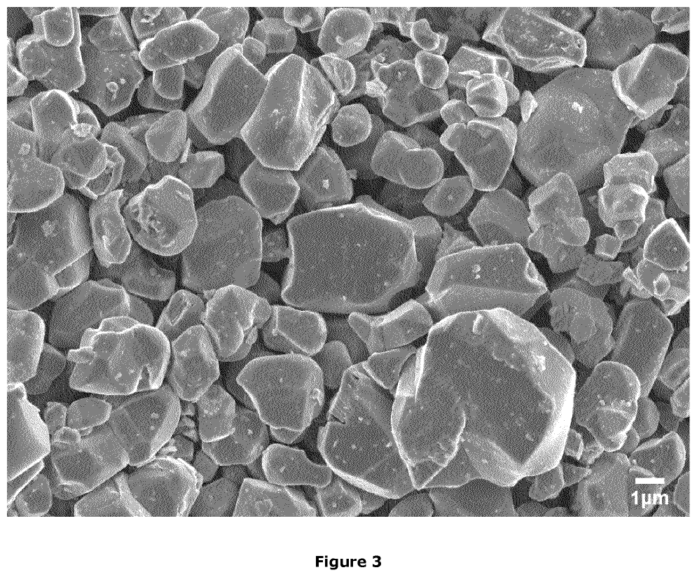

### EXPERIMENTAL TESTS USED IN THE EXAMPLES

The following analysis methods are used in the Examples:

### A) Particle Size Distribution (PSD) Analysis

The PSD is measured using a Malvern Mastersizer 3000 with Hydro MV wet dispersion accessory after dispersing examples as described herein below of positive electrode active material powders in an aqueous medium. To improve the dispersion of the positive electrode active material powder examples, sufficient ultrasonic irradiation and stirring is applied, and an appropriate surfactant is introduced. D50 is defined as the particle size at 50% of the cumulative volume % distribution.

### B) Inductively Coupled Plasma-Optical Emission Analysis (ICP-OES) Analysis

The positive electrode active material examples as described herein below are measured by the Inductively Coupled Plasma-Optical Emission Spectrometry (ICP-OES) method using an Agillent ICP 720-OES. 1 gram of a powder sample of each example is dissolved into 50 mL high purity hydrochloric acid in an Erlenmeyer flask. The flask is covered by a watch glass and heated on a hot plate at 380° C. until complete dissolution of the sample. After being cooled to room temperature, the solution and the rinsing water of Erlenmeyer flask are transferred to a 250 mL volumetric flask. Afterwards, the volumetric flask is filled with DI water up to the 250 ml mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this solution is used for ICP-OES measurement. The contents of Ni, Mn, Co, are expressed as mol % of the total of these contents.

### C) Coin Cell Testing

### C1. Coin Cell Preparation

For the preparation of a positive electrode, a slurry that contains a positive electrode active material powder, conductor (Super P, Timcal), binder (KF #9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### C2. Testing Method

The testing method is a conventional “constant cut-off voltage” test. The conventional coin cell test in the present invention follows the schedule shown in Table 1. Each cell is cycled at 25° C. using a Toscat-3100 computer-controlled galvanostatic cycling station (from Toyo). The schedule uses a 1C current definition of 220 mA/g in the 4.3 V to 3.0 V/Li metal window range. The capacity fading rate (QF) is obtained according to below equation.

$$QF ( \% / cycle ) = ( 1 - \frac{D {Q}_{34}}{D {Q}_{7}} ) \times \frac{1}{27} \times 100$$

wherein DQ1 is the discharge capacity at the first cycle, DQ7 is the discharge capacity at the 7th cycle, DQ34 is the discharge capacity at the 34th cycle.

TABLE 1
Cycling schedule for Coin cell testing method

| | Charge | | | | Discharge | | | |
|---|---|---|---|---|---|---|---|---|
| | | | | V/Li | | | | V/Li |
| | | End | Rest | metal | | End | Rest | metal |
| Cycle | C Rate | current | (min) | (V) | C Rate | current | (min) | (V) |
| 1 | 0.1 | — | 30 | 4.3 | 0.1 | — | 30 | 3.0 |
| 2 | 0.25 | 0.05 | 10 | 4.3 | 0.20 | — | 10 | 3.0 |
| 3 | 0.25 | 0.05 | 10 | 4.3 | 0.50 | — | 10 | 3.0 |
| 4 | 0.25 | 0.05 | 10 | 4.3 | 1.00 | — | 10 | 3.0 |
| 5 | 0.25 | 0.05 | 10 | 4.3 | 2.00 | — | 10 | 3.0 |
| 6 | 0.25 | 0.05 | 10 | 4.3 | 3.00 | — | 10 | 3.0 |
| 7 | 0.25 | 0.1 | 10 | 4.3 | 0.10 | — | 10 | 3.0 |
| 8 | 0.25 | 0.1 | 10 | 4.3 | 1.00 | — | 10 | 3.0 |
| 9-33 | 0.50 | 0.1 | 10 | 4.3 | 1.00 | — | 10 | 3.0 |
| 34 | 0.25 | 0.1 | 10 | 4.3 | 0.10 | — | 10 | 3.0 |

### D) Surface Base Analysis

In the measurement of soluble base content by pH titration, two steps are performed: (a) the reparation of solution, and (b) pH titration. The detailed explanation of each step is as follows: Step (a): The preparation of solution: powder is immersed in deionized water and stirred for min in a sealed glass flask containing 100 ml of deionized water. The amount of positive electrode active material powder is 4 grams. After stirring, to dissolve the base, the suspension of powder in water is filtered to get a clear solution.

Step (b): pH titration: 90 ml of the clear solution prepared in step (a) is used for pH titration by using 0.1M HCl. The flow rate is 0.5 ml/min and the pH value is recorded each 3 seconds. The pH titration profile (pH value as a function of added HCl) shows two clear equivalence (or inflection) points. The first equivalence point (corresponding to a HCl quantity of EP1) at around pH 7.4 results from the reaction of OH and CO₃²⁻ with H⁺. The second equivalence point (corresponding to a HCl quantity of EP2) at around pH 4.7 results from the reaction of HCO3⁻ with H⁺. It is assumed that the dissolved base in deionized water is either LiOH (with a quantity 2*EP1−EP2) or Li₂CO₃ (with a quantity 2*(EP2−EP1)). The obtained values for LiOH and Li₂CO₃ are the result of the reaction of the surface with deionized water.

### E) X-Ray Powder Diffraction (XRD)

### E1) XRD Measurement

The X-ray diffraction pattern of the positive electrode active material powder examples as described herein below is collected with a Rigaku X-Ray Diffractometer Ultima 4 using a Cu Kα radiation source (40 kV, 40 mA) emitting at a wavelength of 1.5418 Å. The instrument configuration is set at: a 1° Soller slit (SS), a 10 mm divergent height limiting slit (DHLS), a 1° divergence slit (DS) and a 0.3 mm reception slit (RS). The diameter of the goniometer is 185 mm. For the XRD, diffraction patterns are obtained in the range of 15-50° (2θ) with a scan speed of 3° per min and a step-size of 0.02° per scan.

### E2) X-Ray Diffractogram Analysis

The diffractogram obtained from E1) is analyzed in Origin 2018b Version b9.5.5.409 according to below steps:
1. Subtract baseline by End Point Weighted mode and 10% end point
2. Nonlinear curve fit using Voigt line each for peak located at 20 between 17.0° to 20.0° for (003) peak and 2θbetween 43.0° to 46.0° for (104) peak. The Voigt line shape is according to below equation:

$$y = {y}_{0} + A \frac{2 ln 2}{{π}^{\frac{3}{2}}} \frac{{w}_{L}}{{w}_{G}^{2}} {\int }_{- ∞}^{∞} \frac{{e}^{- {t}^{2}}}{{( \sqrt{ln 2} \frac{{w}_{L}}{{w}_{G}} )}^{2} + {( \sqrt{4 ln 2} \frac{x - {x}_{c}}{{w}_{G}} - t )}^{2}} d t$$

3. Identify maximum y value from the obtained fitted curve, each for (003) and (104) peak. Intensity ratio (003)/(104) is obtained by dividing maximum y value of (003) peak to maximum y value of (104) peak.

### F) Field Emission-Scanning Electron Microscope (FE-SEM) Analysis

The morphology of positive electrode active materials is analyzed by a Field Emission-Scanning Electron Microscopy (FE-SEM) technique. The measurement is performed with a JEOL JSM 7100F under a high vacuum environment of 9.6×10⁻⁵ Pa at 25° C.

### EXAMPLES

The present invention is further illustrated in the following examples:

### Comparative Example 1

Positive electrode active material CEX1.1 is prepared through a solid-state reaction between a lithium source and a transition metal-based source precursor according to the following steps:
1) Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2) Mixing: precursor prepared from Step 1) is mixed with LiOH and ZrO₂ in an industrial blender to obtain a mixture comprising 0.25 mol % Zr and having a lithium to metal ratio of 1.02.
3) Heating: The mixture from Step 2) is heated under oxygen flow at a first temperature of 700° C. for a first duration of 10 hours and then the temperature is increased to a second temperature of 840° C. for a second duration of 10 hours.
4) Post-treatment: The heated powder from Step 3) is crushed and sieved to obtain a positive electrode active material CEX1.1.

CEX1.2 is prepared according to the same method as CEX1.1, except that the first temperature is 840° C. and the first duration is 10 hours and then the temperature is decreased to the second temperature of 700° C. for a second duration of 2 hours. CEX1.2 is according to the prior art KR20210018139 A.

### Comparative Example 2

CEX2.1 is prepared according to the same method as CEX1.2, except that the second duration is 10 hours.

CEX2.2 is prepared according to the same method as CEX1.2, except that the second duration is 5 hours.

CEX2.3 is prepared according to the same method as CEX1.2, except that the first duration is 5 hours and the second duration is 10 hours.

CEX2.4 is prepared according to the same method as CEX1.2, except that the first duration is 5 hours and the second duration is 5 hours.

CEX2.5 is prepared according to the same method as CEX1.2, except that the second temperature is 660° C. and the second duration is 10 hours.

CEX2.6 is prepared according to the same method as CEX1.2, except that the second temperature is 740° C. and the second duration is 10 hours.

CEX2.7 is prepared according to the same method as CEX1.2, except that the second temperature is 760° C. and the second duration is 10 hours.

CEX2.8 is prepared according to the same method as CEX1.2, except that the second temperature is 660° C. and the second duration is 5 hours.

CEX2.9 is prepared according to the same method as CEX1.2, except that the second temperature is 740° C. and the second duration is 5 hours.

CEX2.10 is prepared according to the same method as CEX1.2, except that the second temperature is 760° C. and the second duration is 5 hours.

### Comparative Example 3

Positive electrode active material CEX3 is obtained through a solid-state reaction between a lithium source and a transition metal-based source precursor in the following method steps:
1) Co-precipitation: a transition metal-based oxidized hydroxide precursor with metal composition of Ni_{0.92}Mn_{0.03}Co_{0.05} is prepared by a co-precipitation process in a large-scale continuous stirred tank reactor (CSTR) with mixed nickel-manganese-cobalt sulfates, sodium hydroxide, and ammonia.
2) Mixing: the precursor prepared from Step 1) and LiOH as a lithium source are homogenously blended at a lithium to metal M (Li/M) ratio of 0.99 in an industrial blending equipment.
3) Heating: The mixture obtained from step 2) is heated at 820° C. under oxygen flow for 10 hours.
4) Post-treatment: The heated powder from Step 3) is crushed and sieved to obtain CEX3.

### Comparative Example 4

CEX4 is prepared according to the same method as CEX3, except that Step 3) heating is conducted at a first temperature of 820° C. for a first duration of 10 hours and then the temperature is decreased to a second temperature of 700° C. for a second duration of 5 hours.

### Comparative Example 5

Positive electrode active material CEX5 is prepared through a solid-state reaction between a lithium source and a transition metal-based source precursor according to the following steps:
1) Co-precipitation: a transition metal oxidized hydroxide precursor with metal composition of Ni_{0.94}Mn_{0.03}Co_{0.03} is prepared by a co-precipitation process in a large-scale continuous stirred tank reactor (CSTR) with mixed nickel manganese cobalt sulfates, sodium hydroxide, and ammonia.
2) Mixing: precursor prepared from Step 1) is mixed with LiOH, ZrO₂, Al₂O₃, in an industrial blender to obtain a mixture comprising 1500 ppm Zr and 700 ppm Al with respect to the total weight of Ni, Mn, and Co and having a lithium to metal ratio of 0.95.
3) Heating: The mixture from Step 2) is heated under oxygen flow at first temperature of 830° C. for 10 hours and then the temperature is decreased to a second temperature of 710° C. for 10 hours.
4) Post-treatment: The heated powder from Step 3) is crushed and sieved to obtain positive electrode active material CEX5.

### Comparative Example 6

Positive electrode active material CEX6.1 is prepared through a solid-state reaction between a lithium source and a transition metal-based source precursor according to the following steps:
1) Co-precipitation: a transition metal oxidized hydroxide precursor with metal composition of Ni_{0.88}Mn_{0.05}Co_{0.07} is prepared by a co-precipitation process in a large-scale continuous stirred tank reactor (CSTR) with mixed nickel manganese cobalt sulfates, sodium hydroxide, and ammonia.
2) Mixing: precursor prepared from Step 1) is mixed with LiOH and ZrO₂ in an industrial blender to obtain a mixture comprising 0.25 mol % Zr with respect to the total molar content of Ni, Mn, and Co and having a lithium to metal ratio of 0.98.
3) Heating: The mixture from Step 2) is heated under oxygen flow at a first temperature of 880° C. for 5 hours and then the temperature is decreased to second temperature of 760° C. for 7.5 hours.
4) Post-treatment: The heated powder from Step 3) is crushed and sieved to obtain positive electrode active material CEX6.1.

CEX6.2 is prepared according to the same method as CEX6.1, except that after the first heating at 880° C., the temperature is slowly decreased to 700° C. with a rate of 30° C./hour and then cooled down to room temperature.

### Comparative Example 7

Positive electrode active material CEX7.1 is obtained through a solid-state reaction between a lithium source and a transition metal-based source precursor according to the following steps:
1) Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2) First mixing: precursor prepared from Step 1) is mixed with LiOH in an industrial blender to obtain a mixture having a lithium to metal ratio of 1.06.
3) Heating: The first mixture from Step 2) is heated at 890° C. under oxygen flow for 10h.
4) Post-treatment: The heated powder from Step 3) is crushed and sieved to obtain positive electrode active material CEX7.1.
5) Wet bead milling: CEX7.1 is bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.
6) Second mixing: the milled product from Step 4) was mixed with H₃BO₃ as B source and WO₃ as W source to obtain a third mixture comprising 250 ppm of B and 2000 ppm of W.
7) Heat treatment: the second mixture from Step 5) was heated at 350° C. for 7 hours under an oxygen atmosphere to obtain CEX7.2 comprising Ni, Mn, and Co in a ratio Ni:Mn:Co of 0.89:0.05:0.06 as measured by ICP-OES. CEX7.2 has a D50 of 4 μm.

Due to the wet milling in step 4) CEX7.2 is a monolithic powder.

### Example 1

Positive electrode active material EX1 is obtained through a solid-state reaction between a lithium source and a transition metal-based source precursor according to the following steps:
1) Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2) First mixing: precursor prepared from Step 1) is mixed with LiOH and ZrO₂ in an industrial blender to obtain a mixture comprising 0.125 mol % Zr and having a lithium to metal ratio of 1.02.
3) Heating: The first mixture from Step 2) is heated under oxygen flow at a first temperature of 870° C. for 10 hours and then temperature is decreased to a second temperature of 700° C. and kept constant for 10 hours.
4) Post-treatment: The heated powder from Step 3) is crushed and sieved to obtain positive electrode active material EX1.1.
5) Wet bead milling: EX1.1 is bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.
6) Second mixing: the milled product from Step 4) was mixed with H₃BO₃ as B source and WO₃ as W source to obtain a third mixture comprising 125 ppm of B and 1000 ppm of W.
7) Heat treatment: the second mixture from Step 5) was heated at 350° C. for 7 hours under an oxygen atmosphere to obtain EX1.2 comprising Ni, Mn, and Co in a ratio Ni:Mn:Co of 0.89:0.05:0.05 as measured by ICP-OES. EX1.2 has a D50 of 4 μm.

Due to the wet milling in step 4) EX1.2 is a monolithic powder.

### Results

The results of the experimental tests used on the examples described herein above are as follows:

TABLE 2
Heating conditions and characterization of positive electrode active material
CEX1.1, CEX1.2, CEX2.1 to CEX2.10, CEX3, CEX4, CEX5, CEX6.1, and CEX6.2

| | First heat | | Second heat | | | | | |
|---|---|---|---|---|---|---|---|---|
| | treatment | | treatment | | ΔT | ICP-OES | Base | XRD |
| | T1 | t1 | T2 | t2 | T1 − T2 | Ni | LiOH | (003)/ |
| ID | (° C.) | (hours) | (° C.) | (hours) | (° C.) | (mol %) | (wt. %) | (104) |
| CEX1.1 | 700 | 10 | 840 | 10 | −140 | 89.5 | 1.49 | 1.528 |
| CEX1.2 | 840 | 10 | 700 | 2 | 140 | 89.8 | 1.43 | 1.549 |
| CEX2.1 | 840 | 10 | 700 | 10 | 140 | 89.5 | 0.63 | 1.682 |
| CEX2.2 | 840 | 10 | 700 | 5 | 140 | 89.4 | 1.02 | 1.614 |
| CEX2.3 | 840 | 5 | 700 | 10 | 140 | 89.4 | 0.47 | 1.643 |
| CEX2.4 | 840 | 5 | 700 | 5 | 140 | 89.5 | 0.77 | 1.649 |
| CEX2.5 | 840 | 10 | 660 | 10 | 180 | 89.5 | 1.21 | 1.760 |
| CEX2.6 | 840 | 10 | 740 | 10 | 100 | 89.5 | 0.51 | 1.576 |
| CEX2.7 | 840 | 10 | 760 | 10 | 80 | 89.5 | 0.57 | 1.570 |
| CEX2.8 | 840 | 10 | 660 | 5 | 180 | 89.4 | 1.25 | 1.589 |
| CEX2.9 | 840 | 10 | 740 | 5 | 100 | 89.4 | 0.85 | 1.595 |
| CEX2.10 | 840 | 10 | 760 | 5 | 80 | 89.5 | 0.70 | 1.555 |
| CEX3 | 820 | 10 | n/a | n/a | n/a | 92.2 | 0.63 | 1.491 |
| CEX4 | 820 | 10 | 700 | 5 | 120 | 92.2 | 0.54 | 1.568 |
| CEX5 | 830 | 10 | 710 | 10 | 120 | 94.0 | 0.21 | 1.559 |
| CEX6.1 | 880 | 5 | 760 | 7.5 | 80 | 89.1 | 0.20 | 1.549 |
| CEX6.2 | 880 | 5 | 700 | n/a | 180 | 89.1 | 0.20 | 1.560 |
| CEX7.1 | 890 | 10 | n/a | n/a | n/a | 89.3 | 2.23 | 1.528 |
| EX1.1 | 870 | 10 | 700 | 10 | 170 | 89.4 | 0.41 | 1.584 |

n/a = not applicable

TABLE 3
Characterization of positive electrode
active material CEX7 and EX1

| | ICP-OES | Base | XRD | Coin cell |
|---|---|---|---|---|
| ID | Ni (mol %) | LiOH (wt. %) | (003)/(104) | QF (%/100) |
| CEX7.2 | 89.3 | 0.22 | 1.858 | 24.5 |
| EX1.2 | 89.4 | 0.10 | 1.934 | 14.9 |

Table 2 summarizes the heating conditions, composition, and XRD peak analysis of examples and comparative examples.

CEX1.1 prepared without second heat treatment at a reduced temperature contains higher amount of LiOH in comparison with CEX2.1 to CEX2.10 which are positive electrode active materials containing the same amount of Ni. Moreover, XRD diffractogram analysis showing peak intensity ratio (003)/(104) of CEX2.1 to CEX2.10 are exceeding 1.53, wherein the maximum intensity of peak (003) is located at 2θ between 17.0° to 20.0° and the maximum intensity of peak (104) is located at 2θ between 43.0° to 46.0°. The intensity ratio of (003)/(104) indicating structure disorder degree wherein lower ratio shows higher structural disorder caused by cation mixing between Li and Ni atoms. Additionally, CEX1.2 prepared with short t2 of 2 hours shows LiOH base of 1.43 wt. % indicating sufficient time at the second temperature is required to mitigate both structural disorder and surface base problems.

CEX2.1 to CEX2.4 are prepared with variation in t1 and t2 showing that t2 of 10 hours is beneficial to decrease LiOH. On the other hand, a prolonged t2 is linked with a lower furnace throughput. CEX2.5 to CEX2.10 are positive electrode active materials prepared with variation in the second heating in time period of 5 to 10 hours. The comparison showing ΔT in the range of 50 to 300° C. is necessary to decrease LiOH impurities.

CEX3 and CEX4 are positive electrode active materials containing around 92 mol % Ni prepared without and with application of a second heat treatment at a reduced temperature, respectively. The comparison shows application of second heat treatment at a reduced temperature decreases LiOH base and maintain (003)/(104) XRD peak ratio higher than 1.53.

CEX7.1 and EX1.1 are positive electrode active materials containing around 89 mol % Ni prepared without and with application of a second heat treatment at a reduced temperature, respectively. The comparison shows application of second heat treatment at a reduced temperature decreases LiOH base and maintain (003)/(104) XRD peak ratio higher than 1.53.

Table 3 summarizes the heating condition, composition, XRD peak analysis, and electrochemical property of CEX7.2 and EX1.2. CEX7.2 and EX1.2 are monolithic positive electrode active material prepared from CEX7.1 and EX1.1, without and with application of a second heat treatment, respectively. The comparison shows application of second heat treatment decreases LiOH base and maintain (003)/(104) XRD peak ratio higher than 1.88. Moreover, capacity fading QF of EX1.2 is significantly improved in comparison with CEX7.2.

1-13. (canceled)

14. A positive electrode active material comprising lithium and a metal other than lithium and oxygen, wherein the metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %,
wherein x≥70.0 mol %,
wherein 0<y≤30.0 mol %,
wherein 0<z≤30.0 mol %,
wherein 0≤a≤5.0 mol %,
wherein an X-Ray diffractogram obtained from Cu K-α X-ray radiation source of the positive electrode active material has a (003) peak located at 2θ from 17.0° to 20.0° and (104) peak located at 2θ from 43.0° to 46.0°, wherein a ratio (maximum intensity of the (003) peak)/(maximum intensity of the (104) peak) is at least 1.880, and
wherein the positive electrode active material is monolithic.

15. The positive electrode active material according to claim 14, wherein the ratio (maximum intensity of the (003) peak)/(maximum intensity of the (104) peak) is at least 1.900.

16. The positive electrode active material according to claim 14, wherein the ratio (maximum intensity of the (003) peak)/(maximum intensity of the (104) peak) is at least 1.920.

17. The positive electrode active material according to claim 14, wherein a molar ratio: Li/(other metal elements than Li) in the first positive electrode active material is at least 0.90 and at most 1.10.

18. The positive electrode active material according to claim 14, wherein x>80.0mol %.

19. The positive electrode active material according to claim 14, wherein x<98.5mol %.

20. The positive electrode active material according to claim 14, wherein (y+z)>1.0 mol %.

21. The positive electrode active material according to claim 14, wherein y>0.5 mol % and wherein z>0.5 mol %.

22. The positive electrode active material according to claim 14, wherein the positive electrode active material comprises LiOH in a content of at most 0.20 wt. % relative to the total weight of positive electrode active material, wherein the content of LiOH is measured by acid-base titration.

23. A method for manufacturing a positive electrode active material according to claim 14, comprising the consecutive steps of:
a. heating a precursor material at a heating temperature T1 between 750° C. and 1000° C., for a time period t1 between 2 and 20 hours to obtain a heated product,
b. cooling the heated product to a second temperature T2 to obtain a first cooled product,
c. further cooling the first cooled product to obtain a second cooled product,
d. milling the second cooled product to obtain a milled product,
e. heating the milled product at a temperature T3 between 200° C. and 900° C. to obtain the positive electrode active material,
wherein step b is cooling the heated product to a second temperature T2 between 600° C. and 800° C. to obtain a second heated product, wherein the average cooling rate is between 10° C./h and 50° C./h,
or wherein step b is cooling the heated product to a second temperature T2 between 650° C. and 900° C. and keeping the temperature T2 for a time t2 between 5 and 20 hours.

24. The method according to claim 23, wherein ΔT=(T1−T2), wherein 20° C.≤ΔT≤400° C.

25. The method according to claim 23, wherein 300° C.≤T3≤800° C.

26. The method according to claim 23, wherein the milling is a wet milling in a milling solution.
